(19) United States
(12) Patent Application Publication
(10) Pub. No.: US 2024/0111114 A1
(43) Pub. Date: Apr. 4, 2024

(54) NODE HARNESS FEED-THROUGH CONNECTOR STRUCTURALLY CONFIGURED TO PERMIT ACCESS TO AN ANGLED PATH IN THE CONNECTOR SO AS TO ENHANCE FEEDING OF A CABLE THROUGH THE ANGLED PATH

(71) Applicant: PPC BROADBAND, INC., East Syracuse, NY (US)

(72) Inventor: Michael LANGMAN, East Syracuse, NY (US)

(73) Assignee: PPC BROADBAND, INC., East Syracuse, NY (US)

(21) Appl. No.: 18/375,370

(22) Filed: Sep. 29, 2023

Related U.S. Application Data
(60) Provisional application No. 63/412,289, filed on Sep. 30, 2022.

(51) Int. Cl. G02B 6/44

(52) U.S. Cl. CPC G02B 6/446

(57) ABSTRACT

A connector for connecting a fiber optic harness to a node in a manner that facilitates the feeding of the optical fibers through the connector, including: a first portion; a second portion that is structurally configured to be removably connected to the first portion; a third portion that is structurally configured to be removably connected to the first portion; and a fourth portion that is structurally configured to removably secure the second portion to the first portion. The third portion may be structurally configured to be removed from the first portion so as to allow a user to access the first portion, thereby enhancing feeding of a fiber optic cable through the first portion.

### CROSS-REFERENCE TO RELATED APPLICATION

This application claims the benefit of U.S. Provisional Application No. 63/412,289 filed Sep. 30, 2022, the disclosure of which is hereby incorporated by reference herein in its entirety.

### BACKGROUND

The present invention relates generally to optical fiber cable management. More particularly, the present invention relates to a connector for connecting an optical fiber cable to a cabinet/node and that redirects the cable at ninety degrees.

It can be difficult to feed the optical fibers of a fiber optic cable through a conventional ninety-degree connector due to, for example, difficulty in feeding the optical fibers into one opening of the connector, bending the optical fibers ninety degrees, and feeding the optical fibers out of the other opening of the connector.

It may be desirable to provide a node harness feed-through connector that is structurally configured to allow a user to access an angled path in the connector, thereby enhancing feeding of the fiber optic cable through the angled path in the connector.

### SUMMARY

The present disclosure provides a connector that simplifies connection of a fiber optic cable/harness to a cabinet/node. In particular, embodiments simplify the feeding of optical fibers of the cable/harness through the connector that connects the cable/harness to the cabinet by providing an access port in the connector that allows an installer to guide the cable/harness through the ninety-degree turn with his/her finger or other tool.

Embodiments provide a connector in which an access portion is structurally configured to provide access to a chamber in a body portion to allow a user to insert the user's finger or a tool into the chamber to facilitate feeding a fiber optic cable through an angled path in the connector.

Embodiments provide a connector for connecting a fiber optic harness having a plurality of optical fibers to a node in a manner that facilitates the feeding of the optical fibers through the connector, including: a body portion; a coupling portion that is structurally configured to be removably connected to the body portion; an access portion that is structurally configured to be removably connected to the body portion; and a retaining portion that is structurally configured to removably secure the coupling portion to the body portion. The coupling portion may be structurally configured to be connected to a node; the coupling portion may comprise a passageway that may be structurally configured to receive a fiber optic cable; the body portion may comprise a chamber inside the body portion and that may be structurally configured to connect to the passageway in the coupling portion; the body portion may comprise a passageway that is connected to the chamber; the passageway in the body portion, the chamber, and the passageway in the coupling portion may form an angled path for feeding the fiber optic cable through the connector and into the node; and the access portion may be structurally configured to be removed from the body portion so as to allow a user to access the chamber, thereby enhancing feeding of the fiber optic cable through the angled path in the connector.

In particular embodiments, the access portion may comprise a threaded portion that may be structurally configured to removably connect the access portion to the body portion.

In particular embodiments, the coupling portion may be connected to the body portion at a first side of the body portion, and the access portion may be connected to the body portion at a second side of the body portion that is opposite to the first side.

In particular embodiments, the coupling portion may comprise a receiving portion that may be structurally configured to receive the retaining portion.

In particular embodiments, the receiving portion may be a groove.

In particular embodiments, an axis of the passageway in the body portion may form a ninety-degree angle with an axis of the passageway in the coupling portion.

In particular embodiments, the retaining portion may comprise an engaging portion that may be structurally configured to engage an engagement portion on the body portion.

In particular embodiments, the retaining portion may be structurally configured to simultaneously secure the coupling portion and the access portion to the body portion.

Particular embodiments include a connector for connecting a fiber optic harness having a plurality of optical fibers to a node in a manner that facilitates the feeding of the optical fibers through the connector, including: a body portion; a coupling portion that is structurally configured to be removably connected to the body portion; an access portion that is structurally configured to be removably connected to the body portion; and a retaining portion that is structurally configured to removably secure the coupling portion to the body portion. The coupling portion may comprise a passageway; the body portion may comprise a chamber that may be structurally configured to connect to the passageway in the coupling portion, and a passageway that is connected to the chamber; the passageway in the body portion, the chamber, and the passageway in the coupling portion may form an angled path; and the access portion may be structurally configured to be removed from the body portion so as to allow a user to access the chamber, thereby enhancing feeding of the fiber optic cable through the angled path in the connector.

In particular embodiments, the coupling portion may be structurally configured to be connected to a node.

In particular embodiments, the passageway of the coupling portion may be structurally configured to receive the fiber optic cable.

In particular embodiments, the access portion may comprise a cap portion.

In particular embodiments, the coupling portion may be connected to the body portion at a first side of the body portion, and the access portion may be connected to the body portion at a second side of the body portion that is opposite to the first side.

In particular embodiments, the coupling portion may comprise a receiving portion that may be structurally configured to receive the retaining portion.

In particular embodiments, the receiving portion may be a groove.

Particular embodiments include a connector for connecting a fiber optic harness having a plurality of optical fibers to a node in a manner that facilitates the feeding of the optical fibers through the connector, including: a first portion; a second portion that is structurally configured to be removably connected to the first portion; a third portion that is structurally configured to be removably connected to the first portion; and a fourth portion that is structurally configured to removably secure the second portion to the first portion. The third portion may be structurally configured to be removed from the first portion so as to allow a user to access the first portion, thereby enhancing feeding of a fiber optic cable through the first portion.

In particular embodiments, the second portion may comprise a passageway; the first portion may comprise a chamber that is structurally configured to connect to the passageway in the second portion; the first portion may comprise a passageway that is connected to the chamber; and the passageway in the first portion, the chamber, and the passageway in the second portion may form an angled path.

In particular embodiments, the first portion may comprise a chamber that is part of the angled path.

In particular embodiments, the first portion may be a body portion, and the second portion may be a coupler portion.

In particular embodiments, the third portion may be a cap portion.

In particular embodiments, the fourth portion may be a retaining portion.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

FIG. 1 shows a conventional node harness connector.

FIG. 2 shows the node harness connector of FIG. 1 in a semi-installed position.

FIG. 3 is a front perspective view of an exemplary node harness connector in accordance with various aspects of the disclosure.

FIG. 4 is a rear perspective view of the node harness connector of FIG. 3.

FIG. 5 is a side view of the node harness connector of FIG. 3.

FIG. 6 is a rear view of the node harness connector of FIG. 3.

FIG. 7 is a front view of the node harness connector of FIG. 3.

FIG. 8 is a top view of the node harness connector of FIG. 3.

FIG. 9 is a bottom view of the node harness connector of FIG. 3.

FIG. 10 is a sectional view of the node harness connector of FIG. 3 taken along section line X-X in FIG. 6.

FIG. 11 is an exploded front perspective view of the node harness connector of FIG. 3.

FIG. 12 is an exploded rear perspective view of the node harness connector of FIG. 3.

FIG. 13 is an exploded sectional view of the node harness connector of FIG. 3.

FIG. 14 is front perspective view of an exemplary node harness connector in accordance with various aspects of the disclosure.

FIG. 15 is a partially disassembled front perspective view of the node harness connector of FIG. 14.

FIG. 16 is a partially disassembled rear perspective view of the node harness connector of FIG. 14.

FIG. 17 is a rear perspective view of the node harness connector of FIG. 14 in a first partially assembled position.

FIG. 18 is a rear perspective view of the node harness connector of FIG. 14 in a second partially assembled position.

FIG. 19 is a rear perspective view of the node harness connector of FIG. 14 in a fully assembled position.

FIG. 20 is a partial rear perspective view of the node harness connector of FIG. 14 in the second partially assembled position.

FIG. 21 is a partial front perspective view of the node harness connector of FIG. 14 in the second partially assembled position.

FIG. 22 is an exploded perspective view of the node harness connector of FIG. 14 showing a retainer in place.

FIG. 23 is an exploded perspective view of the node harness connector of FIG. 14 showing the retainer detached.

FIG. 24 is an exploded front perspective view of the node harness connector of FIG. 14.

FIG. 25 is an exploded rear perspective view of the node harness connector of FIG. 14.

FIG. 26 is a front perspective view of an exemplary node harness connector in accordance with various aspects of the disclosure in a fully assembled position.

FIG. 27 is a rear perspective view of the node harness connector of FIG. 26 in the fully assembled position.

FIG. 28 is an exploded perspective view of the node harness connector of FIG. 26.

FIG. 29 is a front perspective view of the node harness connector of FIG. 26 in a partially assembled position.

FIG. 30 is a rear perspective view of the node harness connector of FIG. 26 in the partially assembled position.

### DETAILED DESCRIPTION OF EMBODIMENTS

Embodiments of the disclosure provide a connector that simplifies connection of a fiber optic cable/harness to a cabinet. In particular, embodiments simplify the feeding of optical fibers of the cable/harness through the connector that connects the cable/harness to the cabinet by providing an access port in the connector that allows an installer to guide the cable/harness through the ninety-degree turn with his/her finger or other tool.

Embodiments provide a connector that is structurally configured to allow a user to access an angled path in the connector, thereby enhancing feeding of a fiber optic cable through the angled path in the connector.

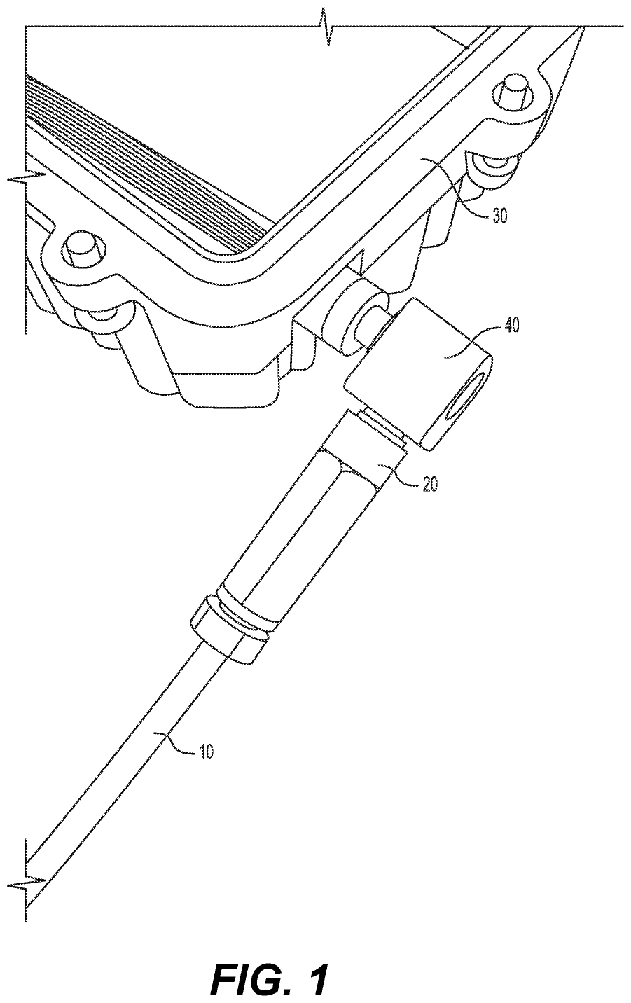

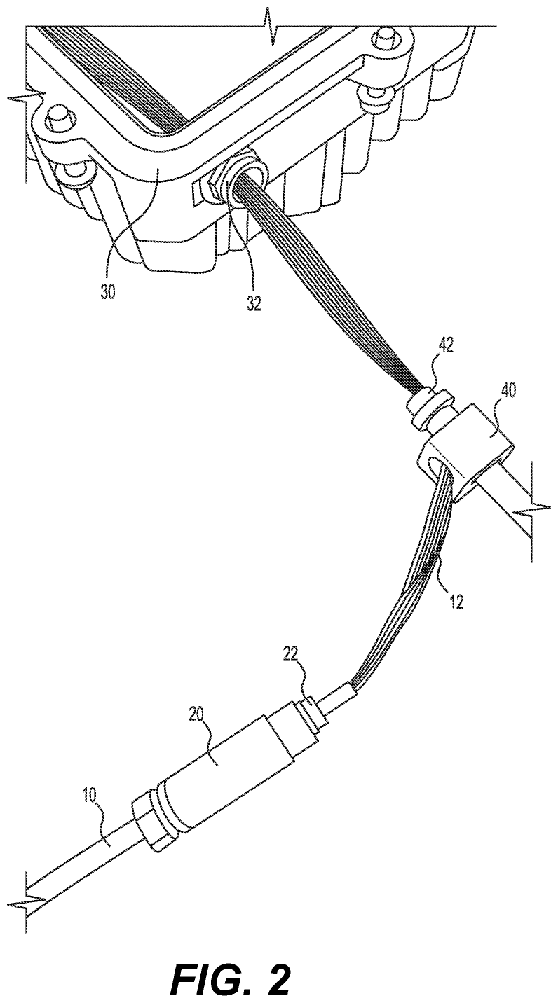

FIGS. 1 and 2 show a conventional ninety-degree connector 40 for connecting a fiber optic cable 10 to a cabinet 30. In this example, fiber optic cable 10 is connected to ninety-degree connector 40 by a connector 20. As shown in FIG. 2, fiber optic cable 10 includes a plurality of optical fibers 12 that extend through ninety-degree connector 40 and into cabinet 30. In practice, a threaded connection 22 of connector 20 is threaded into ninety-degree connector 40 and a threaded connection 432 of ninety-degree connector 40 is threaded into a port 32 on cabinet 30. Feeding optical fibers 12 through ninety-degree connector 40 can be difficult due to the need for optical fibers 12 to bend ninety degrees to pass through ninety-degree connector 40.

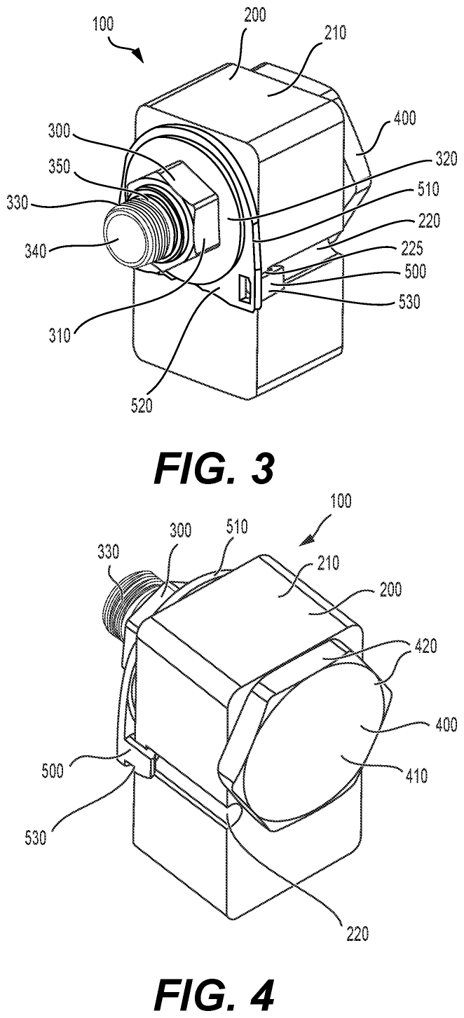

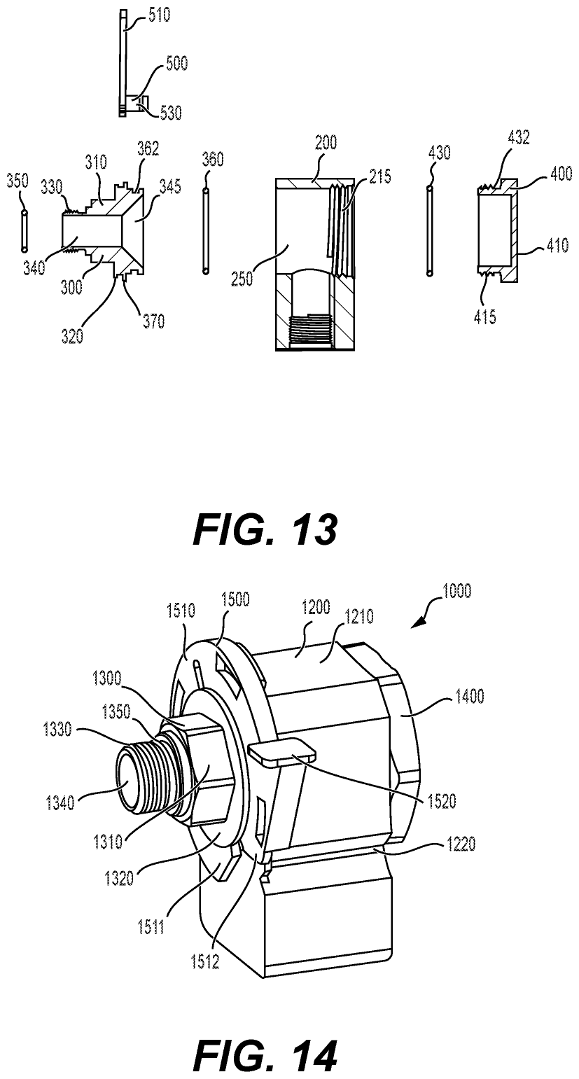

Embodiments of the disclosure provide a solution to the difficulties resulting from the structure of a rigid ninety-degree connector such as connector 40 of FIGS. 1 and 2. FIGS. 3-13 show an exemplary connector 100 in accordance with embodiments of the disclosure. In this example, connector 100 is configured to provide access, through an access port, to an internal space of connector 100 to facilitate feeding fiber optic cables (each often having a cable connector attached) through a ninety-degree bend in connector 100. In this example, connector 100 has a first portion such as, for example, a body portion or a block 200 to which a second portion such as, for example, a coupler portion, an adapter portion or an adapter 300 and a third portion such as, for example, an access portion or a cap 400 are removably attached.

As shown in FIG. 3, block 200 has a main body 210 to which adapter 300 is attached by a fourth portion such as, for example, a retaining portion or a retainer 500 to a front of main body 210. Cap 400 is attached to a rear of main body 210 by, in this example, a threaded connection. Adapter 300 has a gripping feature 310 that is, in this example, a hex nut-shaped feature. Gripping feature 310 is engaged by a tool (or a user's fingers) to rotate adapter 300 in order to thread threaded portion 330 into a cabinet/node such as, for example, cabinet 30 in FIGS. 1 and 2. Adapter 300 has a passageway 340 through which one or more fiber optical cables pass through to enter the cabinet/node. Also shown in FIG. 3 is an O-ring 350 that forms a seal between adapter 300 and the cabinet/node. In this embodiment, adapter 300 has a front flange 320 that extends radially out from a central axis of adapter 300, and a rear flange 370 (not shown in FIG. 3) that extends radially out from the central axis of adapter 300 and parallel to front flange 320.

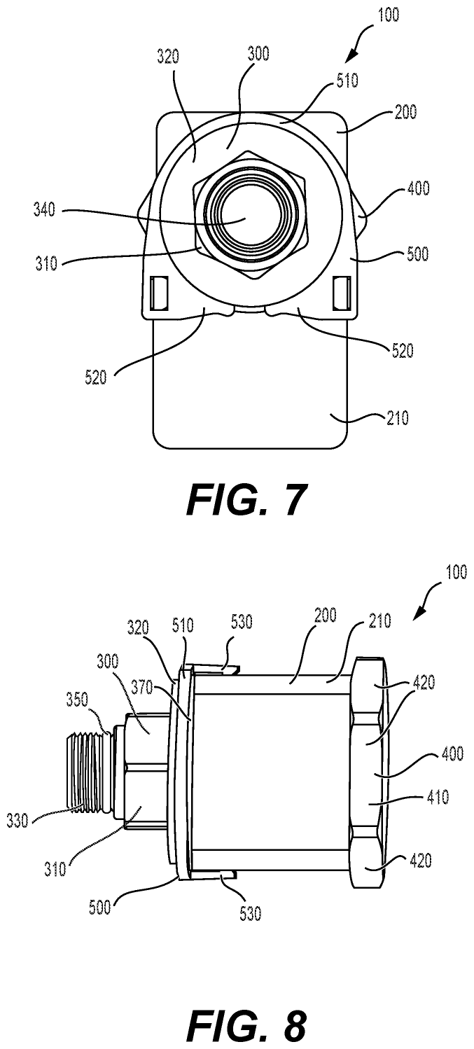

Retainer 500 has a main portion 510 having two ends 520 (See FIG. 7). Near each end 520, a tab extends from main body 510. Each tab 510 is configured to engage an engagement feature 225 on main body 210 of block 200 to secure retainer 500 and adapter 300 to block 200. In this example, each engagement feature 225 is a plate that extends outwardly within a channel 220 in main body 210 of block 200.

FIG. 4 shows cap 400 having a main body 410 and a gripping feature 420 that is, in this example, a hex nut-shaped feature. Gripping feature 420 is engaged by a tool (or a user's fingers) to rotate cap 400 in order to thread cap 400 into main body 210 of block 200.

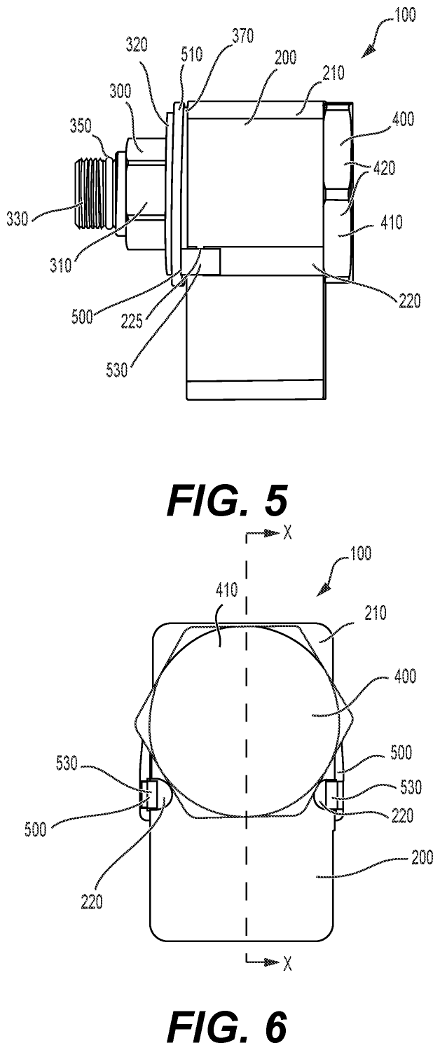

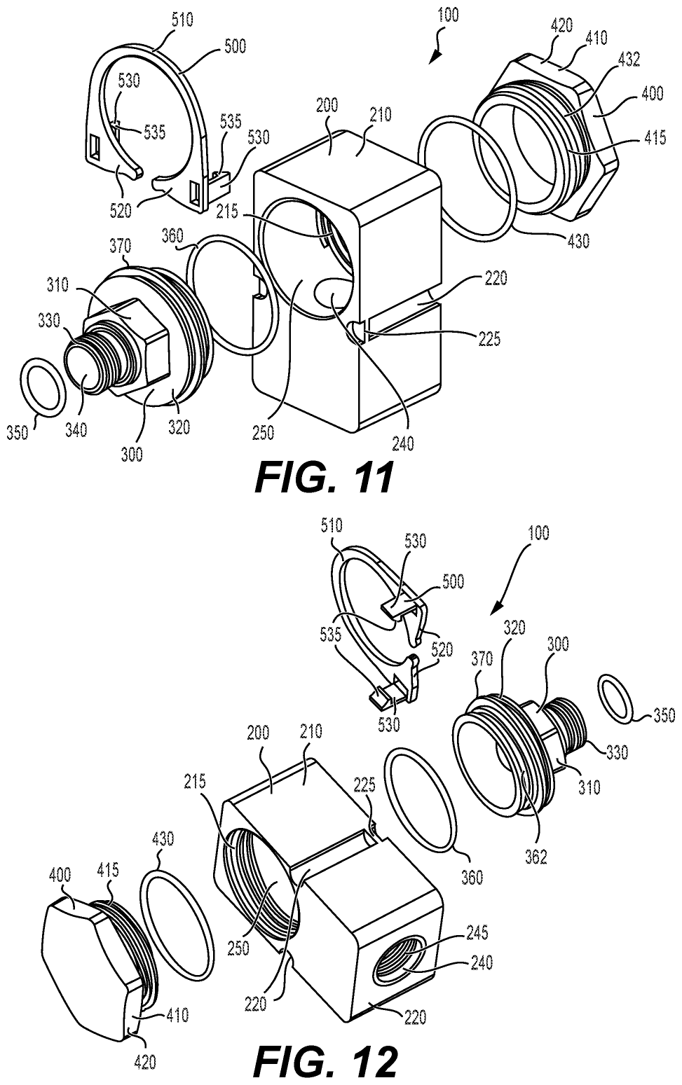

FIG. 5 shows one of two tabs 530 extending toward a rear of connector 100 (toward cap 400) and extending over channel 220 and engagement feature 225. As described in more detail below, each tab 530 has a protrusion 535 (see FIG. 11) that extends inward from tab 530 and is configured to engage engagement feature 225 on main body 210 of block 200. The engagement of protrusions 535 with engagement features 225 secure retainer 500 to main body 210 to prevent retainer 500 moving axially away from main body 210. Main body 510 of retainer 500 is positioned between front flange 320 and rear flange 370 of adapter 300. Main body 510 of retainer 500 has an inner circumference that is smaller than an outer circumference of rear flange 370 that results in retainer 500 securing adapter 300 to main body 210 of block 200.

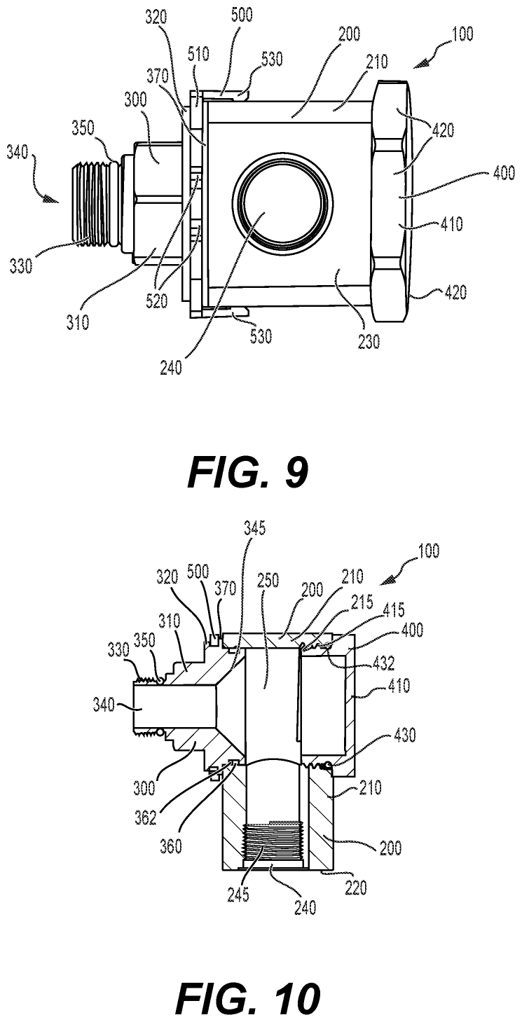

FIG. 6 is a rear view of connector 100 that shows tabs 530 engaged with block 200 at channels 220. FIG. 7 is a front view of connector 100 that shows main body 510 of retainer 500 behind front flange 320. FIG. 8 shows main body 510 of retainer 500 positioned between front flange 320 and rear flange 370. FIG. 9 shows ends 520 of retainer 500 positioned between front flange 320 and rear flange 370. Also shown in FIG. 9 is a passageway 240 in main body 210 that has an opening in a bottom face 230 of main body 210. Passageway 240 connects inside main body 210 to passageway 340 to provide a continuous passageway for fiber optic cables that pass though connector 100.

FIG. 10 is a sectional view of connector 100 taken along section line X-X shown in FIG. 6. FIG. 10 shows a chamber 250 in main body 210 of block 200 that connects passageway 240 and passageway 340. FIG. 10 also shows external threads 415 on cap 400 that engage internal threads 215 in main body 210. In this example, an O-ring 430 is positioned in a groove 432 in cap 400 to create a seal between cap 400 and main body 210. In this example, passageway 240 in main body 210 has internal threads 245 that are configured to engage external threads on a ferrule, or other attachment feature, of a fiber optic cable attached to connector 100. A conical portion 345 in adapter 300 facilitates the fiber optic cables being fed from chamber 250 into passageway 340. Conical portion 345 also provides space that allows a larger radius of bend for the fiber optic cables as they make the ninety-degree turn form passageway 240 to passageway 340.

FIGS. 11-13 show the parts of this embodiment in a disassembled state. In use, connector 100 can facilitate the connection of a fiber optic cable/harness to a cabinet/node.

One example of the use of connector 100 is to connect adapter 300 to the cabinet/node by threading threads 330 into the cabinet/node and tightening adapter 300 by turning gripping feature 310 with a wrench or other tool. Retainer 500 is then positioned around adapter 300 so that main body 510 of retainer 500 is located between front flange 320 and rear flange 370 of adapter 300. Block 200 can then be moved into a position where a rear face of flange 370 contacts main body 210 and O-ring 360 is inside chamber 250 (as shown in FIG. 10). As block 200 is moved axially onto adapter 300, tabs 530 move over channels 220 and engagement features 225. As the rear face of rear flange 370 contacts main body 210 of block 200, protrusions 535 of tabs 530 snap behind engagement features 225 and secure retainer 500 (and thus adapter 300) to main body 210. At this point of partial assembly, cap 400 is not yet installed on main body 210. Without cap 400 installed, chamber 250 is accessible from the rear of main body 210. This allows a user to access chamber 250 though the rear of main body 210 with his/her finger or other tool to guide the fiber optic cables from passageway 240 into passageway 340. After all fiber optic cables are routed through connector 100 and out of passageway 340, cap 400 is installed in main body 210 and tightened to provide a sealed closure.

Another example of the use of connector 100 is to feed the fiber optic cables through main body 210 from passageway 240, through chamber 250, and out of the front of main body 210 before adapter 300 is connected to main body 210. At this point, cap 400 is not yet installed on main body 210. Without cap 400 installed, chamber 250 is accessible from the rear of main body 210. This allows a user to access chamber 250 though the rear of main body 210 with his/her finger or other tool to guide the fiber optic cables from passageway 240, through chamber 250, and out of the front of main body 210. After all fiber optic cables are routed through main body 210, cap 400 is installed in main body 210 and tightened to provide a sealed closure. The fiber optic cables are then passed through passage 340 of adapter 300 and into the cabinet/node. Adapter 300 is then connected to the cabinet/node by threading threads 330 into the cabinet/node and tightening adapter 300 by turning gripping feature 310 with a wrench or other tool. Retainer 500 is then positioned around adapter 300 so that main body 510 of retainer 500 is located between front flange 320 and rear flange 370 of adapter 300. Block 200 can then be moved into a position where a rear face of flange 370 contacts main body 210 and O-ring 360 is inside chamber 250 (as shown in FIG. 10). As block 200 is moved axially onto adapter 300, tabs 530 move over channels 220 and engagement features 225. As the rear face of rear flange 370 contacts main body 210 of block 200, protrusions 535 of tabs 530 snap behind engagement features 225 and secure retainer 500 (and thus adapter 300) to main body 210.

The parts of connector 100 can be assembled in other orders to facilitate installation in differing situations. In many, if not all, of these assembly methods, the access to chamber 250 provided by the removability of cap 400 facilitates the threading of the fiber optic cables through the ninety-degree turn in connector 100.

FIGS. 14-25 show an exemplary connector 1000 in accordance with embodiments of the disclosure. In this example, connector 1000 (similarly to connector 100) is configured to provide access, through an access port, to an internal space of connector 1000 to facilitate feeding fiber optic cables (each often having a cable connector attached) through a ninety-degree bend in connector 1000. In this example, connector 1000 has a block 1200 to which an adapter 1300 and a cap 1400 are removably attached. Many of the connections and functions of the parts of connector 1000 are similar to the connections and functions of the parts of connector 100.

As shown in FIG. 14, block 1200 has a main body 1210 to which adapter 1300 is attached by a retainer 1500 to a front of main body 1210. Cap 1400 is attached to a rear of main body 1210 by, in this example, a threaded connection. Adapter 1300 has a gripping feature 1310 that is, in this example, a hex nut-shaped feature. Gripping feature 1310 is engaged by a tool (or a user's fingers) to rotate adapter 1300 in order to thread threaded portion 1330 into a cabinet/node such as, for example, cabinet 30 in FIGS. 1 and 2. Adapter 1300 has a passageway 1340 through which one or more fiber optical cables pass through to enter the cabinet/node. Also shown in FIG. 14 is an O-ring 1350 that forms a seal between adapter 1300 and the cabinet/node. In this embodiment, adapter 1300 has a front flange 1320 that extends radially out from a central axis of adapter 1300, and a rear flange 1370 (see FIG. 16) that extends radially out from the central axis of adapter 1300 and parallel to front flange 1320.

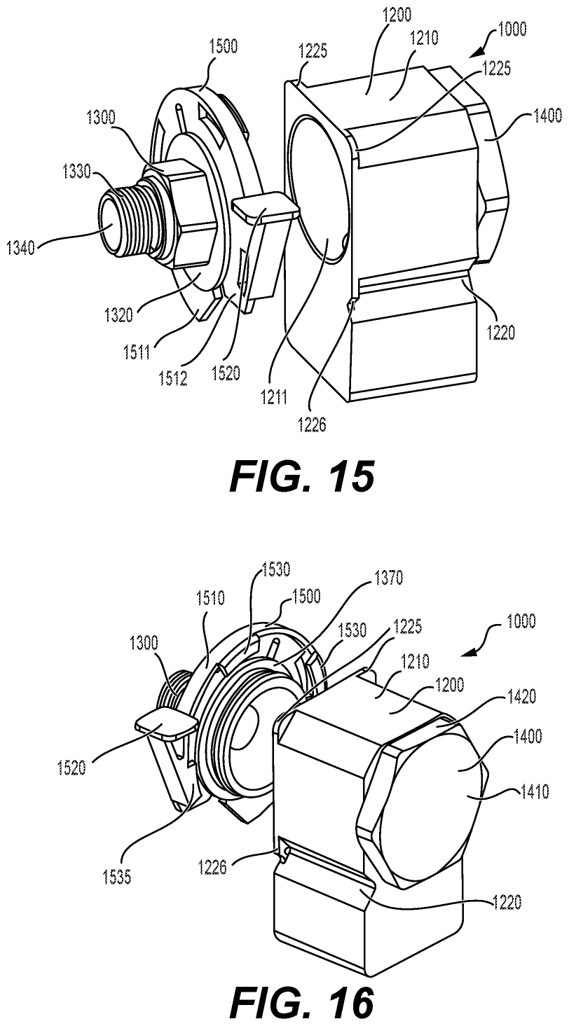

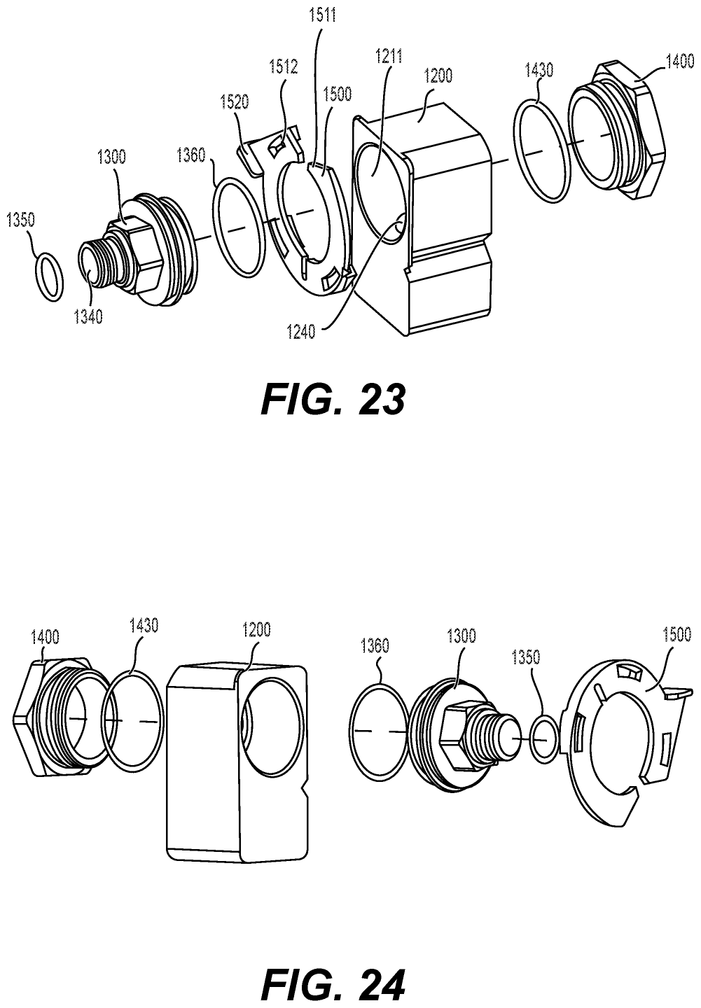

Retainer 1500 has a main portion 1510 having two ends 1511, 1512 (also see FIG. 23). At end 1512, a pad 1520 is provide and configured to be pushed by a user to rotate retainer 1500 relative to main body 1210 of block 1200 (described in more detail, below). As shown in FIG. 16, a plurality of retainer tabs 1530 (in this example, two) extend radially inward from main body 1510 of retainer 1500. Each of retainer tabs 1530 is configured to engage an engagement tab 1225 on main body 1210. As shown in FIG. 15, engagement tabs 1225 extend radially outward from corners of main body 1210. Also shown in FIG. 15, an engagement tab 1226 extends into a channel 1220 in the side of main body 1210. Engagement tab 1226 is configured to engage a retainer tab 1535 (see FIG. 16) at end 1512 of retainer 1500.

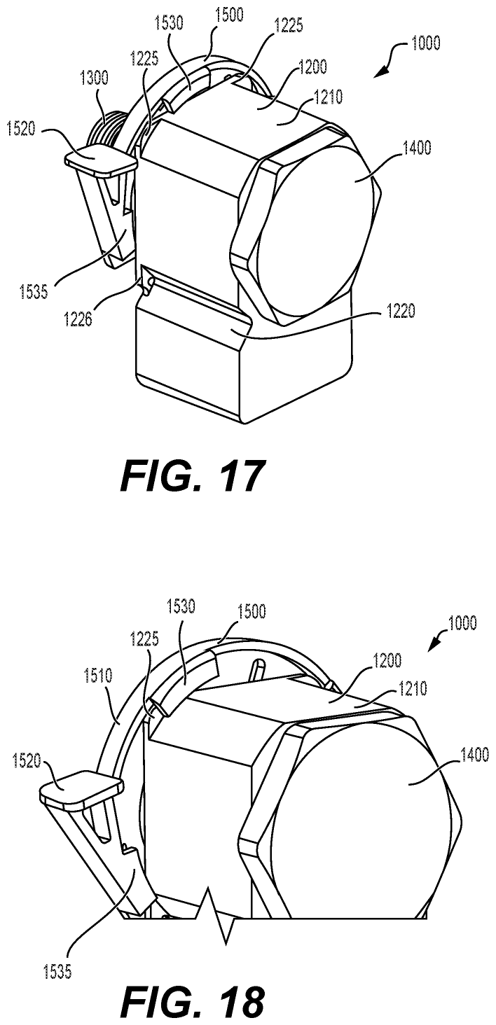

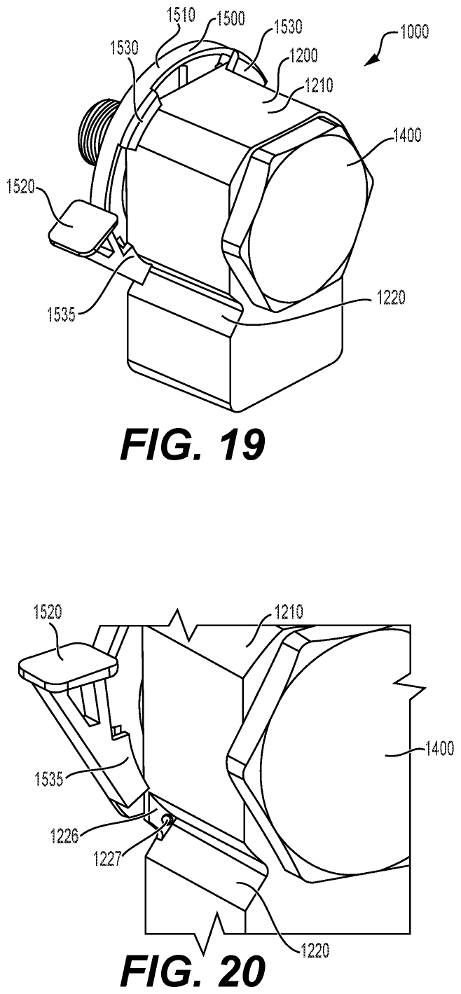

FIG. 16 shows cap 1400 having a main body 1410 and a gripping feature 1420 that is, in this example, a hex nut-shaped feature. Gripping feature 1420 is engaged by a tool (or a user's fingers) to rotate cap 1400 in order to thread cap 1400 into main body 1210 of block 1200. Also shown in FIG. 16 is an O-ring 1370 on adapter 1300 that forms a seal between adapter 1300 and main body 1210. FIG. 16 shows retainer 1500 mounted on adapter 1300 before adapter 1300 is connected to main body 1210. FIG. 17 shows adapter in place on the front face of main body 1210 before retainer 1500 is rotated to secure adapter 1300 to main body 1210. After adapter 1300 is in the position shown in FIG. 17, a user presses on pad 1520 to rotate retainer 1500 relative to main body 1210. FIG. 18 shows retainer rotated slightly such that retainer tabs 1530 have partially engaged engagement tabs 1225. Progressing to FIG. 19, further rotation of retainer 1500 relative to main body 1210 results in complete engagement of retainer tabs 1530 and engagement tabs 1225. FIG. 19 shows retainer 1500 in the fully engaged position.

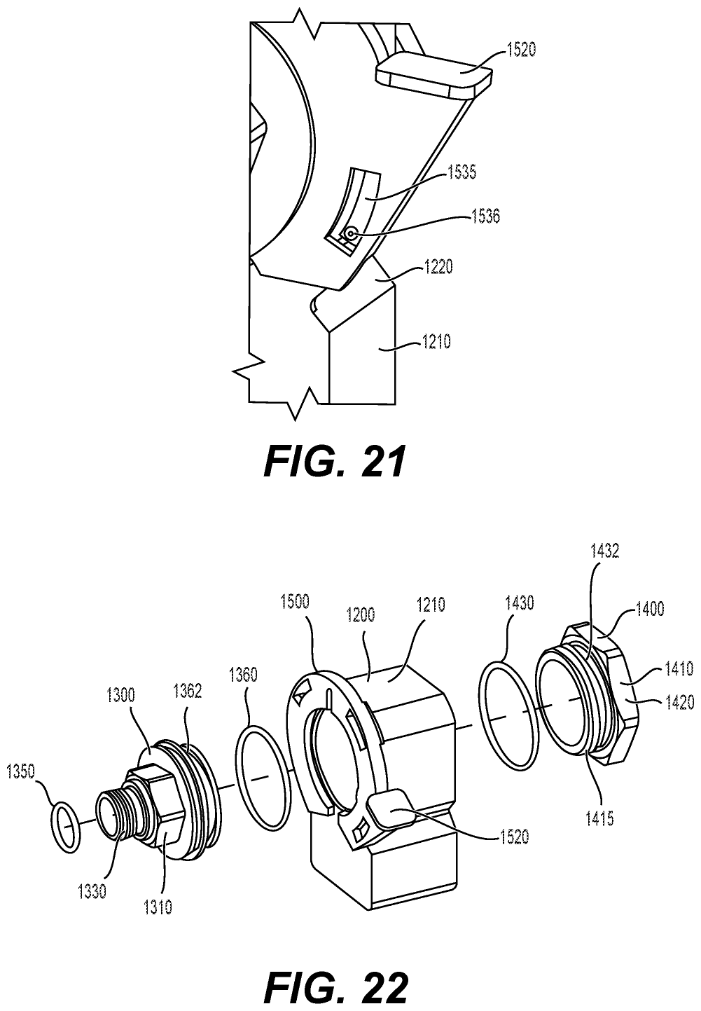

The engagement of retainer tab 1535 with engagement tab 1226 is described with reference to FIGS. 20 and 21. FIG. 20 shows a recess 1227 on engagement tab 1226 that is configured to receive a protrusion 1536 on retainer tab 1535 (see FIG. 21). As retainer 1500 is rotated as described above, retainer tab 1535 engages engagement tab 1226 to the point where protrusion 1536 is received by recess 1227 and secures retainer 1500 in place. Although this example shows recess 1227 on engagement tab 1226 and protrusion 1536 on retainer tab 1535, other examples reverse the locations of recess 1227 and protrusion 1536, or use a different engagement feature.

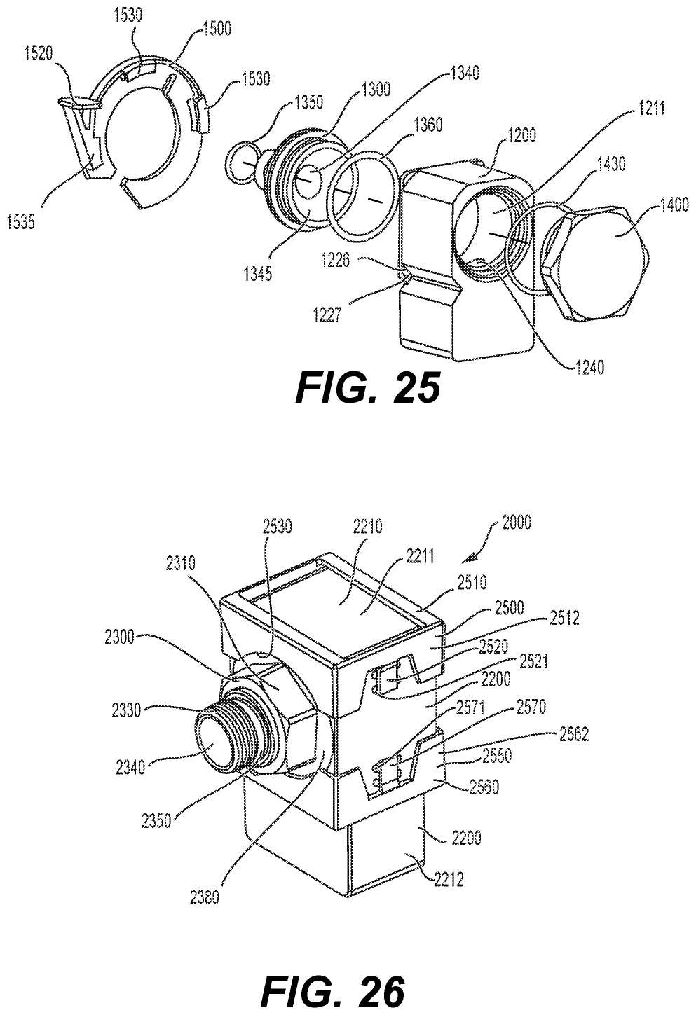

FIGS. 22-25 are exploded views of connector 1000. FIG. 22 shows retainer 1500 in place on main body 1210. FIGS. 23-25 shows retainer 1500 detached from main body 1210. FIG. 25 shows conical section 1345 of adapter 1300. Similarly to connector 100, conical section 1345 facilitates the fiber optic cables being fed from chamber 1211 into passageway 1340. Conical portion 1345 also provides space that allows a larger radius of bend for the fiber optic cables as they make the ninety-degree turn from a passageway 1240 in main body 1210 to passageway 1340 in adapter 1300.

One example of the use of connector 1000 is to connect adapter 1300 to the cabinet/node by threading threads 1330 into the cabinet/node and tightening adapter 1300 by turning gripping feature 1310 with a wrench or other tool. Retainer 1500 is then positioned around adapter 1300 so that main body 1510 of retainer 1500 is located between front flange 1320 and rear flange 1370 of adapter 1300. Block 1200 can then be moved into a position where a rear face of flange 1370 contacts main body 1210 and O-ring 1360 is inside chamber 1211. As block 1200 is moved axially onto adapter 1300, the rear face of rear flange 1370 contacts main body 1210 of block 1200. Retainer 1500 is then rotated relative to main body 1210 to engage retainer tabs 1530 with engagement tabs 1225, and engage retainer tabs 1535 with engagement tab 1226. At this point of partial assembly, cap 1400 is not yet installed on main body 1210. Without cap 1400 installed, chamber 1211 is accessible from the rear of main body 1210. This allows a user to access chamber 1211 though the rear of main body 1210 with his/her finger or other tool to guide the fiber optic cables from passageway 1240 into passageway 1340. After all fiber optic cables are routed through connector 1000 and out of passageway 1340, cap 1400 is installed in main body 1210 and tightened to provide a sealed closure.

Another example of the use of connector 1000 is to feed the fiber optic cables through main body 1210 from passageway 1240, through chamber 1211, and out of the front of main body 1210 before adapter 1300 is connected to main body 1210. At this point, cap 1400 is not yet installed on main body 1210. Without cap 1400 installed, chamber 1211 is accessible from the rear of main body 1210. This allows a user to access chamber 1211 though the rear of main body 1210 with his/her finger or other tool to guide the fiber optic cables from passageway 1240, through chamber 1211, and out of the front of main body 1210. After all fiber optic cables are routed through main body 1210, cap 1400 is installed in main body 1210 and tightened to provide a sealed closure. The fiber optic cables are then passed through passage 1340 of adapter 1300 and into the cabinet/node. Adapter 1300 is then connected to the cabinet/node by threading threads 1330 into the cabinet/node and tightening adapter 1300 by turning gripping feature 1310 with a wrench or other tool. Retainer 1500 is then positioned around adapter 1300 so that main body 1510 of retainer 1500 is located between front flange 1320 and rear flange 1370 of adapter 1300. Block 1200 can then be moved into a position where the rear face of flange 1370 contacts main body 1210 and O-ring 1360 is inside chamber 1211. Retainer 1500 is then rotated relative to main body 1210 to engage retainer tabs 1530 with engagement tabs 1225, and engage retainer tabs 1535 with engagement tab 1226.

The parts of connector 1000 can be assembled in other orders to facilitate installation in differing situations. In many, if not all, of these assembly methods, the access to chamber 1211 provided by the removability of cap 1400 facilitates the threading of the fiber optic cables through the ninety-degree turn in connector 1000.

FIGS. 26-30 show an exemplary connector 2000 in accordance with embodiments of the disclosure. In this example, connector 2000 (similarly to connectors 100 and 1000) is configured to provide access, through an access port, to an internal space of connector 2000 to facilitate feeding fiber optic cables (each often having a cable connector attached) through a ninety-degree bend in connector 2000. In this example, connector 2000 has a block 2200 to which an adapter 2300 and a cap 2400 are removably attached. Many of the connections and functions of the parts of connector 2000 are similar to the connections and functions of the parts of connectors 100 and 1000.

Unlike the embodiments illustrated by connectors 100 and 1000, connector 2000 uses two retainers 2500, 2550 to secure adapter 2300 to block 2200, instead of one retainer. In the example shown in FIGS. 26-30, retainers 2500, 2550 are identical and interchangeable. They are numbered differently solely to simplify the description of connector 2000.

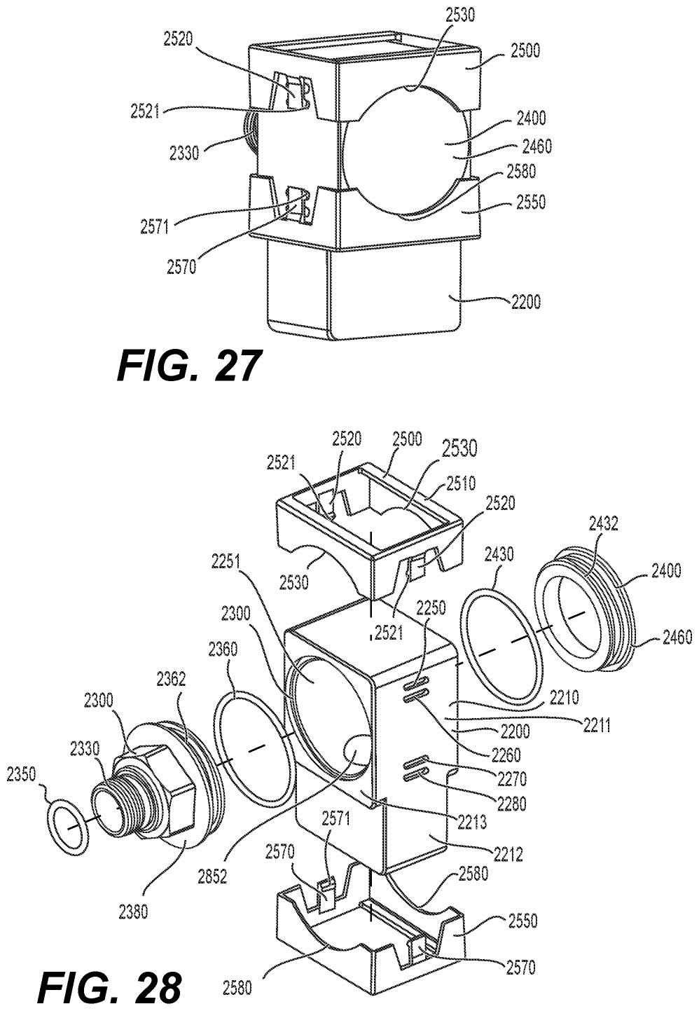

As shown in FIG. 26, block 2000 has a main body 2210 to which adapter 2300 is attached by retainers 2500, 2550 to a front of main body 2210. Cap 2400 is attached to a rear of main body 2210 by, in this example, retainers 2500, 2550. Adapter 2300 has a gripping feature 2310 that is, in this example, a hex nut-shaped feature. Gripping feature 2310 is engaged by a tool (or a user's fingers) to rotate adapter 2300 in order to thread threaded portion 2330 into a cabinet/node such as, for example, cabinet 30 in FIGS. 1 and 2. Adapter 2300 has a passageway 2340 through which one or more fiber optical cables pass through to enter the cabinet/node. Also shown in FIG. 26 is an O-ring 2350 that forms a seal between adapter 2300 and the cabinet/node. In this embodiment, adapter 2300 has a flange 2380 that extends radially out from a central axis of adapter 2300. As shown in FIG. 28, flange 2380 is received in a recess 2300 in main body 2210 such that a front face of flange 2380 is flush with a front face 2213 of main body 2210. Similarly, cap 2400 has a flange 2460 that extends radially out from a central axis of cap 2400. As shown in FIGS. 27 and 30, flange 2460 is received in a recess in main body 2210 such that a front face of flange 2460 is flush with a rear face 2214 of main body 2210.

As shown in FIG. 28, main body 2210 has a chamber 2251 that is connected to a passageway 2252 that extends to, and out of, the bottom of main body 2210. An O-ring 2360 is located in a groove 2362 in adapter 2300 to form a seal between adapter 2300 and main body 2210. An O-ring 2430 is located in a groove 2432 in cap 2400 to form a seal between cap 2400 and main body 2210.

In this example, main body 2210 has a larger portion 2211, and a smaller portion 2212 located below portion 2211. The smaller cross-section of smaller portion 2211 allows a retainer 2550 to slide upward on main body 2210 to the point where it engages flanges 2380 and 2460 (described in more detail, below).

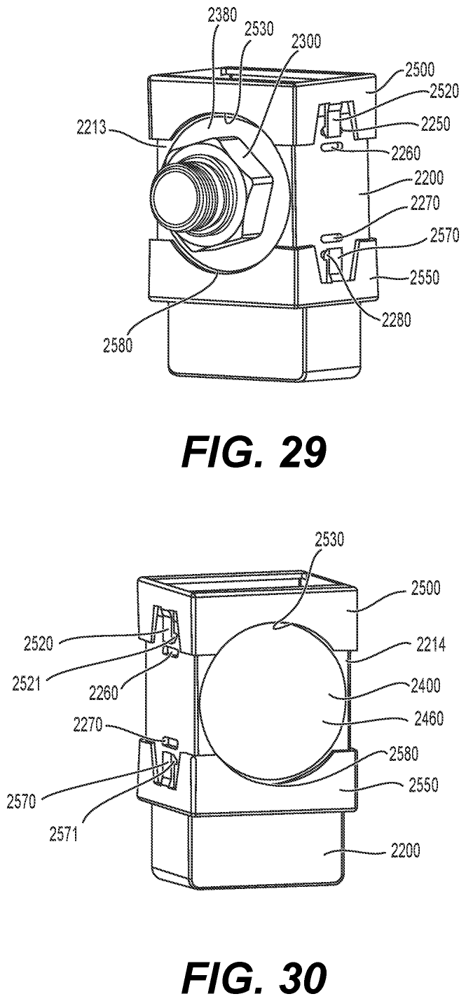

Retainer 2500 has a main portion 2510 that includes a skirt 2512 that extends downward around a top portion of larger portion 2211 of main body 2110. In this example, two tabs 2520 extend downward from main portion 2510 and are configured to engage recesses 2250, 2260 in main body 2210. In this example, two tabs 2520 extend downward from main portion 2510 and are configured to engage recesses 2250, 2260 in main body 2210. Similarly, retainer 2550 has a main portion 2560 that includes a skirt 2562 that extends upward around a lower portion of larger portion 2211 of main body 2110. In this example, two tabs 2570 extend upward from main portion 2560 and are configured to engage recesses 2270, 2280 in main body 2210. FIGS. 26 and 27 show retainers 2500, 2550 in a fully installed position in which retainers 2500, 2550 secure adapter 2300 and cap 2400 to main body 2210. FIGS. 29 and 30 show retainers 2500, 2550 in a partially installed position in which retainers 2500, 2550 do not secure adapter 2300 and cap 2400 to main body 2210.

Referring to FIGS. 29 and 30, when adapter 2300 and cap 2400 are fully inserted into main body 2210, a front face of flange 2380 is flush with front face 2213 of main body 2210 and a front face of flange 2460 is flush with a rear face 2214 of main body 2210. In the partially installed position shown in FIGS. 29 and 30, retainer 2500 is held in position by tabs 2520 engaging recesses 2250, and retainer 2550 is held in position by tabs 2570 engaging recesses 2280. In this position, flange 2380 can be inserted into main body 2210 due to cutouts 2530 and 2580 in retainers 2500 and 2550, respectively. Similarly, flange 2460 can be inserted into main body 2210 due to cutouts 2530 and 2580 in retainers 2500 and 2550. Retainers 2500, 2550 can be mounted to main body 2210 in the positions shown in FIGS. 29 and 30 before or after adapter 1300 and cap 2400 are fully inserted into main body 2210. After adapter 2300 and cap 2400 are fully inserted into main body 2210, retainers 2500, 2550 are moved into the positions shown in FIGS. 26 and 27.

FIGS. 26 and 27 show retainers 2500, 2550 in the fully installed position in which retainers 2500, 2550 secure adapter 2300 and cap 2400 to main body 2210. In the fully installed position, skirts 2512 and 2562 overlap flange 2380 and flange 2460 to prevent flange 2380 and flange 2460 from being moved out of main body 2210, as shown in FIGS. 26 and 27. In this position, tabs 2520 engage recesses 2260 and tabs 2570 engage recesses 2270 to maintain retainers 2500, 2550 in the fully installed position.

As shown by the above examples, embodiments of the disclosure provide a connector that simplifies connection of a fiber optic cable/harness to a cabinet. In particular, embodiments simplify the feeding of optical fibers of the cable/harness through the connector that connects the cable/harness to the cabinet by providing an access port, covered by a removable cap, in the connector that allows an installer to guide the cable/harness through the ninety-degree turn with his/her finger or other tool.

Although the illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

Various changes to the foregoing described and shown structures will now be evident to those skilled in the art. Accordingly, the particularly disclosed scope of the invention is set forth in the following claims.

What is claimed is:

1. A connector for connecting a fiber optic harness having a plurality of optical fibers to a node in a manner that facilitates the feeding of the optical fibers through the connector, comprising:
a body portion;
a coupling portion that is structurally configured to be removably connected to the body portion;
an access portion that is structurally configured to be removably connected to the body portion;
a retaining portion that is structurally configured to removably secure the coupling portion to the body portion;
wherein the coupling portion is structurally configured to be connected to a node;
wherein the coupling portion comprises a passageway that is structurally configured to receive a fiber optic cable;
wherein the body portion comprises a chamber inside the body portion and that is structurally configured to connect to the passageway in the coupling portion;
wherein the body portion comprises a passageway that is connected to the chamber;
wherein the passageway in the body portion, the chamber, and the passageway in the coupling portion form an angled path for feeding the fiber optic cable through the connector and into the node; and
wherein the access portion is structurally configured to be removed from the body portion so as to allow a user to access the chamber, thereby enhancing feeding of the fiber optic cable through the angled path in the connector.

2. The connector of claim 1, wherein the access portion comprises a threaded portion that is structurally configured to removably connect the access portion to the body portion.

3. The connector of claim 1, wherein the coupling portion is connected to the body portion at a first side of the body portion, and the access portion is connected to the body portion at a second side of the body portion that is opposite to the first side.

4. The connector of claim 1, wherein the coupling portion comprises a receiving portion that is structurally configured to receive the retaining portion.

5. The connector of claim 4, wherein the receiving portion is a groove.

6. The connector of claim 1, wherein an axis of the passageway in the body portion forms a ninety-degree angle with an axis of the passageway in the coupling portion.

7. The connector of claim 1, wherein the retaining portion comprises an engaging portion that is structurally configured to engage an engagement portion on the body portion.

8. The connector of claim 1, wherein the retaining portion is structurally configured to simultaneously secure the coupling portion and the access portion to the body portion.

9. A connector for connecting a fiber optic harness having a plurality of optical fibers to a node in a manner that facilitates the feeding of the optical fibers through the connector, comprising:
a body portion;
a coupling portion that is structurally configured to be removably connected to the body portion;
an access portion that is structurally configured to be removably connected to the body portion;
a retaining portion that is structurally configured to removably secure the coupling portion to the body portion;
wherein the coupling portion comprises a passageway;
wherein the body portion comprises a chamber that is structurally configured to connect to the passageway in the coupling portion, and a passageway that is connected to the chamber;
wherein the passageway in the body portion, the chamber, and the passageway in the coupling portion form an angled path; and
wherein the access portion is structurally configured to be removed from the body portion so as to allow a user to access the chamber, thereby enhancing feeding of the fiber optic cable through the angled path in the connector.

10. The connector of claim 9, wherein the coupling portion is structurally configured to be connected to a node.

11. The connector of claim 9, wherein the passageway of the coupling portion is structurally configured to receive the fiber optic cable.

12. The connector of claim 9, wherein the access portion comprises a cap portion.

13. The connector of claim 9, wherein coupling portion is connected to the body portion at a first side of the body portion, the access portion is connected to the body portion at a second side of the body portion that is opposite to the first side.

14. The connector of claim 9, wherein the coupling portion comprises a receiving portion that is structurally configured to receive the retaining portion.

15. The connector of claim 14, wherein the receiving portion is a groove.

16. A connector for connecting a fiber optic harness having a plurality of optical fibers to a node in a manner that facilitates the feeding of the optical fibers through the connector, comprising:
a first portion;
a second portion that is structurally configured to be removably connected to the first portion;
a third portion that is structurally configured to be removably connected to the first portion;
a fourth portion that is structurally configured to removably secure the second portion to the first portion; and
wherein the third portion is structurally configured to be removed from the first portion so as to allow a user to access the first portion, thereby enhancing feeding of a fiber optic cable through the first portion.

17. The connector of claim 16, wherein the second portion comprises a passageway;
wherein the first portion comprises a chamber that is structurally configured to connect to the passageway in the second portion, wherein the first portion comprises a passageway that is connected to the chamber; and
wherein the passageway in the first portion, the chamber, and the passageway in the second portion form an angled path.

18. The connector of claim 17, wherein the first portion comprises a chamber that is part of the angled path.

19. The connector of claim 16, wherein the first portion is a body portion, and the second portion is a coupler portion.

20. The connector of claim 16, wherein the third portion is a cap portion.

21. The connector of claim 16, wherein the fourth portion is a retaining portion.
